(19) United States
(12) Patent Application Publication
(10) Pub. No.: US 2006/0194087 A1
(43) Pub. Date: Aug. 31, 2006

(54) Cooling system and method for using fuel of fuel cell as refrigerant

(75) Inventors: Hee-Sung Park, Suwon-si (KR); Kwang Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/325,415

(22) Filed: Jan. 5, 2006

(30) Foreign Application Priority Data
Feb. 28, 2005 (KR) 2005-0016398

(51) Int. Cl. H01M 8/04; H01M 8/12; H01M 8/24

(52) U.S. Cl. 429/26; 429/14; 429/18

(57) ABSTRACT

A cooling system using fuel of a fuel cell as a refrigerant comprises a fuel cartridge for storing fuel for a fuel cell stack that generates electricity and heat by an electrochemical reaction. The system further comprises a heat collection unit for lowering a temperature of an electronic device by allowing the fuel to absorb the heat generated from the electronic device, and a heat dissipating unit for dissipating the heat absorbed from the electronic device to an external side. The fuel stored in the fuel cartridge circulates between the heat collection unit, the heat dissipating unit, and the fuel cartridge, thereby lowering the temperature of the electronic device.

### CROSS-REFERENCE TO RELATED PATENT APPLICATION

This application claims the benefit under 35 U.S.C. § 119(e) of Korean Patent Application No. 10-2005-0016398, filed Feb. 28, 2005, in the Korean Intellectual Property Office, the entire disclosure of which is hereby incorporated by reference.

### BACKGROUND OF THE INVENTION

1. Field of the Invention

The present invention relates to a cooling system and method for an electronic device. More particularly, the present invention relates to a cooling system and method where fuel of a fuel cell may be used as a refrigerant for cooling an electronic device.

2. Description of the Related Art

Generally, a fuel cell is a device in which chemical energy released by the oxidation of a liquid or gaseous fuel is converted directly into electrical energy.

A fuel cell is a power generator that does not need a recharging process, unlike a conventional battery, and continuously generates electric power as long as fuel is being supplied. Fuel cells include anode and cathode electrodes, and electrolyte disposed between the anode and cathode electrodes. When hydrogen and oxygen flow into the anode and cathode electrodes, electricity, heat and water are generated. A variety of fuels, such as natural gas, methanol, and gasoline, may be used. Theses fuels may be used after being reformed into hydrogen by a fuel reformer.

Fuel cells have advantages in that they are environmentally-oriented and have high energy converting efficiency. That is, since fuel cells are designed to directly convert chemical energy into electrical energy, they have an electrical generating efficiency that is higher than that of conventional generating methods, which go through a variety of energy converting devices. In addition, because fuel cells do not create emissions such as Nitrogen Oxide (Nox) or Sulfur Oxide (Sox), they stand in the spotlight as the next power generator.

Recently, Fuel cells have been used on a small-scale as power generators for home service or commercial service, and as a power generator for portable devices. For example, a commercially produced micro fuel cell having an output of less than 50 watts is becoming more feasible as the technology quickly develops.

Particularly, the rapid development of a direct methanol fuel cell (DMFC) that can be downsized makes the possibility of a practical application more likely.

The DMFC is designed to generate electric power using a chemical reaction between methanol and oxygen. The unit cell of the DMFC includes, as shown in FIG. 1, an anode 2, a cathode 3, and a hydrogen ion exchange film 1. The hydrogen ion exchange film 1 is interposed between the anode 2 and the cathode 3. The electrode of anode 2 includes a diffusion layer 22 for feeding and diffusing fuel, a catalytic layer 21 for oxidation-reduction, and an electrode support 23. Likewise, the electrode of cathode 3 includes a diffusion layer 32 for feeding and diffusing fuel, a catalytic layer 31 for oxidation-reduction, and an electrode support 33.

Anode 2, cathode 3, and the hydrogen ion exchange film 1 constitute a membrane electrode assembly (MEA). The hydrogen ion exchange film 1 is formed of a solid polymer electrolyte.

In anode 2, methanol reacts with water to generate hydrogen ions, electrons, and CO₂ by oxidation. The hydrogen ions are transmitted to cathode 3 via the hydrogen ion exchange film 1. In cathode 3, the hydrogen ions react with oxygen to generate water.

The above-described reaction can be represented by three reaction schemes. Reaction schemes 1 and 2 represent the reactions in the anode and cathode, and reaction scheme 3 represents the reaction in the unit cell.

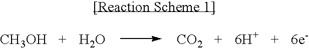

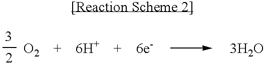

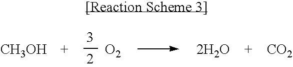

The voltage generated in the unit cell of the DMFC is theoretically about 1.2V and the open circuit voltage under normal temperature and pressure condition is less than 1V. However, the actual operational voltage is about 0.4-0.6V due to a voltage drop caused by the activation overvoltage and the resistance overvoltage. Thus, in order to obtain the desired voltage capacity, a plurality of unit cells connected in series must be used.

Generally, an electronic device generates heat as it operates, and heat causes deterioration of performance of the electronic device. Thus, the electronic device needs a cooling system for dissipating heat. A natural cooling system using air may be used. However, air cannot provide sufficient cooling efficiency. Thus, there is a need for a cooling system that can provide sufficient cooling efficiency while being designed in a simple structure.

### SUMMARY OF THE INVENTION

Aspects of the present invention provide a cooling system using fuel of a fuel cell as refrigerant that can absorb heat generated in an electronic device by allowing a portion of the fuel to circulate in the electronic device, thereby properly maintaining a temperature of the electronic device.

According to an aspect of the present invention, there is provided a cooling system using fuel of a fuel cell as a refrigerant. The system comprises a fuel cartridge for storing fuel used for a fuel cell stack that generates electricity and heat by an electrochemical reaction. The system further comprises a heat collection unit for lowering a temperature of an electronic device by allowing the fuel to absorb the heat generated from the electronic device, and a heat dissipating unit for dissipating the heat absorbed from the electronic device to an external side, wherein the fuel stored in the fuel cartridge circulates between the heat collection unit, the heat dissipating unit, and the fuel cartridge, thereby lowering the temperature of the electronic device.

According to another aspect of the present invention, there is provided a cooling method where fuel of a fuel cell is used for cooling.

### BRIEF DESCRIPTION OF THE DRAWINGS

The above and other exemplary features and advantages of the present invention will become more apparent by describing in detail exemplary embodiments thereof with reference to the accompanying drawings, in which:

FIG. 1 shows a schematic view of a typical fuel cell;

FIG. 2 depicts a view of a cooling system using fuel of a fuel cell as a refrigerant according to an embodiment of the present invention; and

FIG. 3 depicts a view of a cooling system using fuel of a fuel cell as a refrigerant according to another embodiment of the present invention.

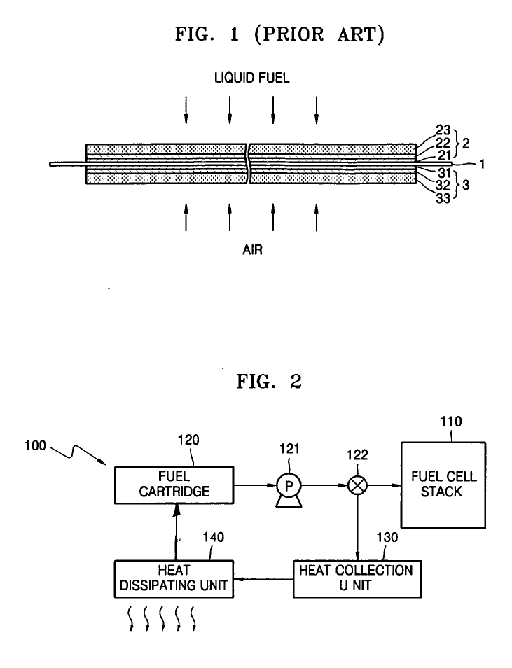

### DETAILED DESCRIPTION OF THE INVENTION

FIG. 2 shows a schematic view of a cooling system using fuel of a fuel cell as a refrigerant according to an embodiment of the present invention.

Referring to FIG. 2, cooling system 100 includes a fuel cartridge 120, a pump 121, a dispense valve 122, a heat collection unit 130, and a heat dissipating unit 140.

Fuel cartridge 120 is used for storing fuel used in a fuel cell stack 110. When the fuel is fully consumed, it is replaced with a new fuel cartridge. The storage capacity of fuel cartridge 120 may vary according to the system in which it is applied. However, when considering small or portable electronic devices, stores of 300 ml capacity may be proper. Because the fuel is used as a refrigerant for absorbing heat generated by the electronic device, fuel cartridge 120 functions as a refrigerant storing tank.

Fuel cell stack 110 is comprised of a plurality of unit cells so that the hydrogen and oxygen electrochemically react with each other to generate electricity and heat. The fuel used for fuel cell stack 110 may be methanol, which is typically used for a direct methanol fuel cell (DMFC) and is suitable for supplying electricity to small or portable electronic devices. A 30% methanol solution may be also used as fuel.

Heat collection unit 130 allows the heat generated from electronic devices (not shown) to be absorbed by the fuel, thereby lowering the temperature of the electronic devices. Heat collection unit 130 may be formed in one of a micro channel type, an impact jet type, and a spray type that are well known in the art.

Heat dissipating unit 140 is designed to dissipate the heat generated by the electronic devices and absorbed by the fuel as the fuel passes through the heat collection unit 130 to an external side. That is, heat dissipating unit 140 may include a plurality of tubes through which the fuel passes, with air passages being formed around the tubes, and a plurality of fins formed on the tubes. In order to further enhance the heat dissipation efficiency, a fan may be used.

Pump 121 is designed to supply the fuel stored in fuel cartridge 120 to the fuel cell stack 110, and to allow fuel to pass through heat collection unit 230 and heat dissipating unit 140. Pump 121 may be any fluid pump suitable for pumping fuel, such as a centrifugal pump and a diapharm pump. Particularly, the pump may be an electrokinetic type or an electromagnetic type using the physical/chemical characteristics of fuel.

Dispense valve 122 is designed to dispense fuel to the fuel cell stack 110 and heat collection unit 130. Dispense valve 122 may be a 3-way valve that can adjust the amount of fuel to be used as refrigerant.

The operation of a cooling system having the structure shown by FIG. 2 will now be described.

When pump 121 is operated, the fuel stored in fuel cartridge 120 is partly directed to fuel cell stack 110 via dispense valve 122 to be used as the fuel for the fuel cell stack 110, and is partly directed to heat collection unit 130.

The fuel directed to heat collection unit 130 absorbs heat from electronic devices (not shown), and in so doing lowers the temperate of the electronic devices. The fuel increases in temperature by absorbing the heat, which is then dissipated while the fuel passes through the heat dissipating unit 140, thereby causing the fuel to be lowered in the temperature. The fuel is then returned to fuel cartridge 120 to repeatedly undergo the above-described process.

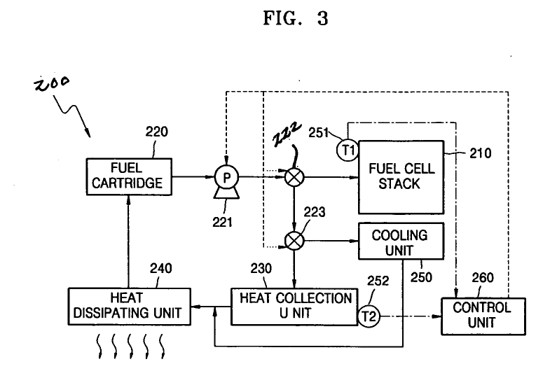

FIG. 3 shows a cooling system according to another embodiment of the present invention.

Referring to FIG. 3, cooling system 200 comprises a fuel cartridge 220, a pump 221, first and second dispense valves 222 and 223, a heat collection unit 230, a heat dissipating unit 240, a cooling unit 250, first and second temperature detecting units 251 and 252, and a control unit 260.

Fuel cartridge 220 is used for storing fuel in a fuel cell stack 210. When the fuel is fully consumed, it is replaced with a new fuel cartridge. The storage capacity of fuel cartridge 220 may vary according to the system in which it is applied. However, when considering small or portable electronic devices, scores ml or 300 ml capacity may be proper. Because the fuel is used as a refrigerant for absorbing the heat generated by the electronic device, fuel cartridge 220 functions as a refrigerant storing tank.

Fuel cell stack 210 is comprised of a plurality of unit cells so that the hydrogen and oxygen electrochemically react with each other to generate electricity and heat. The fuel used for fuel cell stack 210 may be methanol, which is typically used for the DMFC and is suitable for supplying electricity to small or portable electronic devices. A 30% methanol solution may be also used as fuel.

Heat collection unit 230 allows the heat generated from electronic devices (not shown) to be absorbed by the fuel, thereby lowering the temperature of the electronic devices. Heat collection unit 230 may be formed in one of a micro channel type, an impact jet type, and a spray type that are well known in the art.

Cooling unit 250 is deigned to absorb the heat generated by the electrochemical reaction within fuel cell stack 210, thereby lowering the temperature of fuel cell stack 210. Cooling unit 250 may be formed of a plurality of cooling plates having a channel-shaped passage between stacks, or a cooling jacket defining an outer case, so that the fuel absorbs the heat from fuel cell stack 210 while passing through cooling unit 250.

Cooling unit 250 is supplied with a portion of fuel from dispense valve 223. Fuel absorbing heat from fuel cell stack 210 is directed to the heat dissipating unit 240.

Heat dissipating unit 240 is designed to dissipate the heat generated by the electronic devices and absorbed by the fuel as the fuel passes through the heat collection unit 130. The heat absorbed by the fuel is dissipated as the fuel passes through cooling unit 250 to an external side. That is, heat dissipating unit 140 may include a plurality of tubes through which the fuel passes, with air passage being formed around the tubes, and a plurality of fins formed on the tubes. In order to further enhance the heat dissipation efficiency, a fan may be used.

Pump 221 is designed to supply the fuel stored in fuel cartridge 220 to the fuel cell stack 210, and to allow fuel to pass through heat collection unit 230, heat dissipating unit 240, and cooling unit 250. Pump 221 may be any fluid pump suitable for pumping fuel, such as a centrifugal pump and a diapharm pump. Particularly, the pump may be an electrokinetic type or an electromagnetic type using the physical/chemical characteristics of fuel.

The first dispense valve 222 is designed to dispense fuel to the fuel cell stack 210 and second dispense unit 223. First dispense valve 222 may be a 3-way valve that can adjust the amount of fuel that will be used or the amount of fuel that will be used as refrigerant. The second dispense valve 223 is designed to dispense fuel to the heat collection unit 230 and cooling unit 230. Second dispense valve 222 may also be a 3-way valve that can adjust the amount of fuel that will be dispensed to the heat collection unit 230 and cooling unit 230.

First and second temperature detecting units T1 251 and T2 252 are attached to fuel cell stack 210 and heat collection unit 230, respectively, to detect the temperatures of fuel cell stack 210 and heat collection unit 230. The detected temperature signals are transmitted to control unit 260.

Control unit 260 is connected to pump 221 and to the first and second dispense valves 222 and 223 to compare the temperatures detected by temperature detecting units T1 251 and T2 252 with a preset temperature value. Control unit 260 controls pump 221 and first and second dispense valves 222 and 223 to adjust the flow rate of the fuel, thereby properly maintaining the temperatures of fuel cell stack 210 and heat collection unit 230.

The operation of a cooling system having the structure shown by FIG. 3 will now be described.

When pump 221 is operated, the fuel stored in fuel cartridge 220 is partly directed to fuel cell stack 210 via first dispense valve 222 to be used as fuel for fuel cell stack 210. Fuel is also partly directed to the second dispense valve 223.

The fuel directed to second dispense valve 223 is partly directed to cooling unit 250 to be used as refrigerant for absorbing the heat created by fuel cell stack 210 Fuel is also partly directed to heat collection unit 230 to be used as refrigerant for absorbing heat from created by the electronic devices.

Fuel used as a refrigerant in heat collection unit 230 and fuel used as a refrigerant in cooling unit 250 dissipate heat while passing through dissipating unit 240. Fuel is then returned to fuel cartridge 220 to repeatedly undergo the above-described process.

A cooling system in accordance with embodiments of the present invention using the fuel of fuel cells as a refrigerant may have the following exemplary advantages:

first, since the fuel is used as a refrigerant, the heat dissipation performance can be effectively realized without using additional refrigerant;

second, the heat generated from the fuel cell and the heat generated from the electronic devices can be simultaneously dissipated; and

third, since the power supply function and cooling function of the fuel cell are combined with each other, the overall structure of the cooling system can be simplified.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A cooling system using fuel of a fuel cell as a refrigerant, comprising:
a fuel cartridge for storing fuel for a fuel cell stack;
a heat collection unit for lowering the temperature of an electronic device by allowing the fuel to absorb the heat generated from the electronic device; and
a heat dissipating unit for dissipating the heat absorbed from the electronic device,
wherein the fuel stored in the fuel cartridge circulates between the heat collection unit, the heat dissipating unit, and the fuel cartridge.

2. The cooling system of claim 1, further comprising a dispense valve for continuously dispensing fuel stored in the fuel cartridge to the fuel cell stack and the heat collection unit.

3. The cooling system of claim 1, further comprising a pump for supplying fuel stored in the fuel cartridge to the fuel cell stack and to the heat collection unit.

4. The cooling system of claim 1, further comprising
a control unit controlling a flow rate of the fuel to properly maintain a temperature of the heat collection unit by comparing a detected temperature of the heat collection unit with a preset value.

5. The cooling system of claim 4, further comprising a first dispense valve for continuously dispensing fuel stored in the fuel cartridge to the fuel cell stack and the heat collection unit.

6. The cooling system of claim 4, further comprising a pump for supplying fuel stored in the fuel cartridge to the fuel cell stack and to the heat collection unit.

7. The cooling system of claim 4, further comprising a temperature detecting unit for detecting the temperature of the heat collection unit.

8. The cooling system of claim 4, further comprising a cooling unit for absorbing the heat generated by the fuel cell stack to lower the temperature of the fuel cell stack.

9. The cooling system of claim 8, further comprising a second dispense valve for dispensing fuel to the cooling unit before the fuel is dispensed to the heat collection unit.
The cooling system of claim 8, wherein fuel discharged from the cooling unit is directed to the heat dissipating unit.

11. A method of operating a cooling system using fuel of a fuel cell as a refrigerant, the method comprising:
pumping fuel stored in a fuel cartridge through a dispense valve to a fuel cell stack;
diverting at least a portion of fuel from the dispense valve to a heat collection unit that receives heat from an external source, thereby causing heat to be transferred to the fuel;
passing fuel from the heat collection unit to a heat dissipating unit; and
passing fuel from the heat dissipating unit back to the fuel cartridge.

12. A method of operating a cooling system using fuel of a fuel cell as a refrigerant, the method comprising:
pumping with a pump fuel stored in a fuel cartridge through a first dispense valve to a fuel cell stack for creating electrical power;
communicating the temperature of the fuel cell stack to a control unit;
diverting at least a portion of fuel from the first dispense valve to a second dispense valve;
diverting at least a portion of fuel from the second dispense valve to a cooling unit for absorbing;
diverting at least a portion of fuel from the second dispense valve to a heat collection unit;
communicating the temperature of the heat collection unit to the control unit, wherein the control unit is in communication with the pump and the first and second dispense valves;
passing fuel from the heat collection unit to a heat dissipating unit; and
passing fuel from the heat dissipating unit back to the fuel cartridge.

13. The method of claim 12, wherein fuel is pumped at a rate dictated by the control unit.

14. The method of claim 12, wherein the heat collection unit receives heat from an external source, thereby causing heat to be transferred to the fuel.
